(19) United States
(12) Patent Application Publication
(10) Pub. No.: US 2016/0102818 A1
(43) Pub. Date: Apr. 14, 2016

(54) LED-BASED LIGHTING MODULE USING SLOW DECAY PHOSPHOR TO REDUCE FLICKER

(71) Applicant: VastView Technology Inc., Hsinchu County (TW)

(72) Inventors: Hung-Chi Chu, Hsinchu County (TW); Yuhren Shen, Hsinchu County (TW)

(21) Appl. No.: 14/512,470

(22) Filed: Oct. 13, 2014

(51) Int. Cl. F21K 99/00; F21V 9/16; H05B 33/08

(52) U.S. Cl. CPC F21K 9/56; H05B 33/0845; F21V 9/16

(57) ABSTRACT

An LED-based lighting module comprises an LED lighting unit with voltage dependent brightness and a cover disposed to cover all or a portion of light output paths of the LED lighting unit. The cover comprises slow decay phosphor that can suppress the brightness variation of the LED lighting unit to reduce flicker without sacrificing power factor.

### BACKGROUND OF THE INVENTION

1. Field of the Invention

The present invention relates generally to light emitting diode (LED) based lighting apparatus, and more particularly to an AC powered LED-based lighting module with low flicker.

2. Description of Related Arts

In recent years, high voltage LED-based lighting apparatus have been developed to replace the conventional incandescent and fluorescent lamps. In order to increase the brightness of an LED-based light, a number of LEDs are usually connected in series to form an LED-based lighting string and a number of LED-based lighting strings may further be connected in series to form a lighting apparatus. The operating voltage required by each lighting string typically is related to the forward voltage of the LEDs in each lighting string, how many LEDs are employed for each of the lighting string and how they are interconnected, and how the respective lighting strings are organized to receive power from a power source.

Accordingly, in many applications, some type of voltage conversion device is required in order to provide a generally lower operating voltage to one or more LED-based lighting strings from more commonly available higher power supply voltages. The need of a voltage conversion device reduces the efficiency, costs more and also makes it difficult to miniaturize an LED-based lighting device.

In order to increase the efficiency and miniaturize the LED-based lighting apparatus, many techniques have been developed for the apparatus to use operating voltages such as 120V AC or 240V AC without requiring a voltage conversion device. In general, the LEDs in the apparatus are divided into a number of LED segments that can be selectively turned on or off by associated switches or current sources, and a controller is used to control the switches or current sources as the operating AC voltage increases or decreases.

A major drawback of powering an LED-based lighting module with AC power using various controlling switches or circuits is that the brightness of the LED-based lighting module is proportional to the rectified voltage level of the rectified AC voltage source. As a result, the LED light has high flicker because the brightness changes significantly from zero to its maximum level of the rectified AC voltage.

Without good voltage regulation, the brightness of the LED light varies dramatically at frequency of 100 Hz/120 Hz. The high flicker is not only visible but also causes health concerns to people. FIG. 1 shows an LED-based lighting apparatus powered by a rectified AC voltage source 101 along with a switching mode driving circuit 102. In order to reduce flicker, large capacitor C1 or C2 as shown in FIG. 1 is used to improve the voltage regulation.

FIG. 2 shows another LED-based lighting apparatus powered by a rectified AC voltage source 201. The LED-based lighting apparatus has a linear LED driving unit 202 with voltage dependent brightness. A large capacitor 203 is also used to reduce the voltage ripple of the rectified AC voltage source 201. One disadvantage of using a large capacitor is that the LED-based lighting apparatus cannot last long because of the shorter lifetime of the large capacitor.

The use of large capacitors also presents a design challenge between reducing the flicker and increasing the power factor of the LED-based lighting apparatus. US Patent Application Publications 2014/0015441, 2014/0042925 and 2014/0125238 are a few techniques that provide tradeoffs between power factor and flicker. There is a strong demand for reducing the flicker of the LED-based lighting apparatus without sacrificing its lifetime and power factor in the LED lighting industry.

### SUMMARY OF THE INVENTION

The present invention has been made to provide an LED-based lighting apparatus with low flicker and high power factor without using large capacitors. Accordingly, the LED-based lighting apparatus of the present invention is powered with a rectified AC voltage source in association with a cover or plate comprising slow decay phosphor for covering all or partial paths of the light output.

In accordance with the present invention, the high flicker resulted from the large brightness variation is suppressed because the brightness variation is reduced after the LED light passes through the cover or plate comprising slow decay phosphor. The slow decay phosphor cover or plate can be applied to LED-based lighting modules with a linear driving circuit or a switching mode driving circuit. It is especially suitable for simple and low cost linear driving circuits to achieve both high efficiency and high power factor.

### BRIEF DESCRIPTION OF THE DRAWINGS

The present invention will be apparent to those skilled in the art by reading the following detailed description of preferred embodiments thereof, with reference to the attached drawings, in which:

FIG. 1 shows a conventional LED-based lighting apparatus with a switching mode driving circuit;

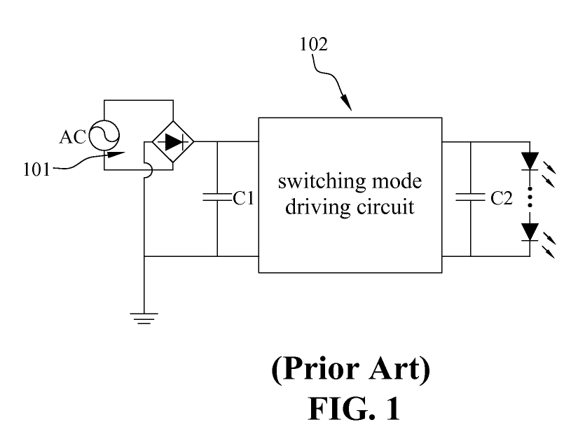

FIG. 2 shows a conventional LED-based lighting apparatus with a linear driving circuit;

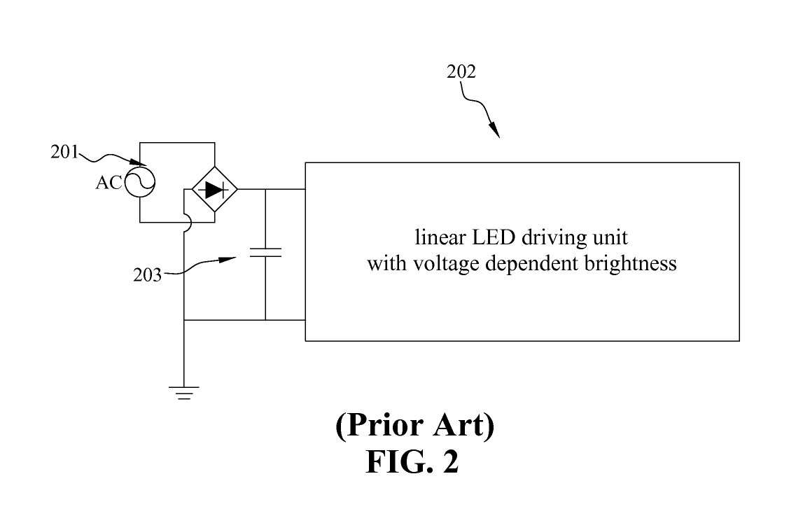

FIG. 3 shows an LED-based lighting module with all paths of the light output covered by a cover comprising slow decay phosphor according to the present invention; and

FIG. 4 shows an LED-based lighting module with partial paths of light output covered by a plate comprising slow decay phosphor according to the present invention.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

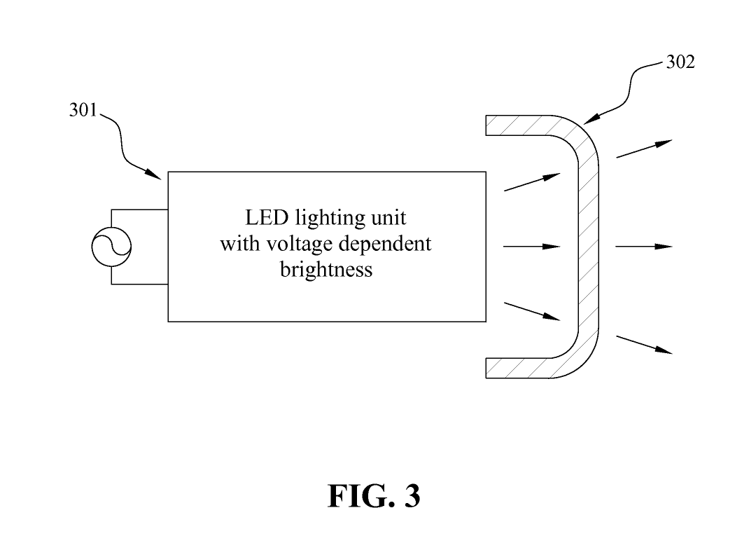

FIG. 3 shows an LED-based lighting module having an LED lighting unit 301 with voltage dependent brightness powered by an AC source. The LED light output has large brightness variation with high flicker. As shown in FIG. 3, a cover 302 is disposed to cover all paths of the LED light output. The cover 302 is made of a material comprising slow decay phosphor to reduce the brightness variation.

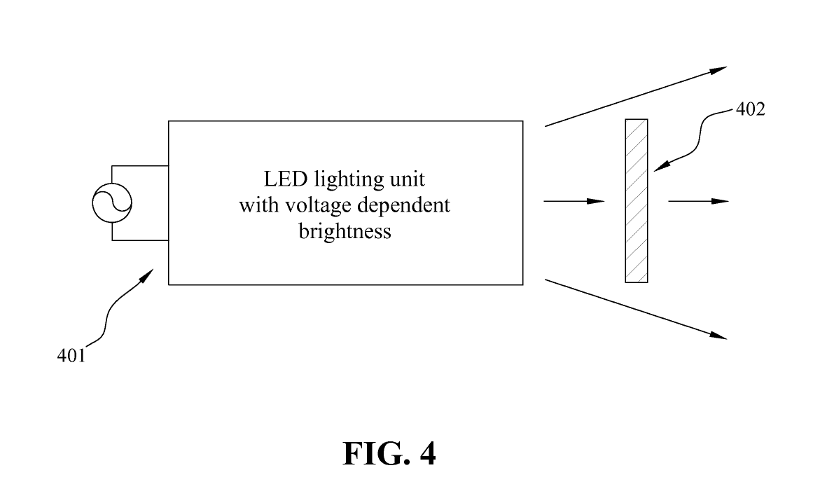

In accordance with the present invention, the paths of the LED light output may also be covered only partially. FIG. 4 shows an LED-based lighting module in which a plate 402 comprising slow decay phosphor is disposed to partially cover the paths of the light output of an LED lighting unit 401 with voltage dependent brightness.

According to the characteristic of phosphor, the decay of after-glow light intensity of first-order type phosphor can be expressed as:

I(t)=I₀×e^{-t/τ},

where τ is a decay time constant and I₀ is the initial after-glow light intensity. For simplicity, we will use the above expression as approximation. It should be noted that phosphor of other types can also be used in the present invention.

From the above expression, it can be seen that the effect of the slow decay phosphor is like a low pass filter with a low frequency pole at 1/τ. For effectively reducing the flicker, it is preferred that the brightness variation be reduced by at least 5% at frequency of 120 Hz. In other words, the decay time constant in the above expression should satisfy:

$$\frac{1}{\sqrt{1 + {( 2 π \times 120 \times τ )}^{2}}} \leq 0.95 ,$$

i.e., the decay time constant τ≧0.436 ms. According to the preferred decay time constant, the 10% decay time of phosphor can be calculated as:

ln 10×τ≧1.004 ms.

According to the present invention, slow decay phosphor is used to reduce the flicker, the phosphor can be disposed anywhere in the LED-based lighting module as long as it is in the path of the light output to fully or partially cover the light output path. FIGS. 3 and 4 illustrate that a cover or a plate comprising slow decay phosphor can be disposed in the LED-based lighting module. The slow decay phosphor can also be coated directly on the LEDs or comprised in other optical elements in the LED-based lighting module.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An LED-based lighting module, comprising:
an LED lighting unit with voltage dependent brightness; and
slow decay phosphor disposed at light output paths of the LED lighting unit;
wherein the slow decay phosphor has a 10% decay time larger than 1 ms.

2. The LED-based lighting module as claimed in claim 1, wherein a portion of all the light output paths of the LED lighting unit is covered by the slow decay phosphor.

3. The LED-based lighting module as claimed in claim 1, wherein all the light output paths of the LED lighting unit are covered by the slow decay phosphor.

4. The LED-based lighting module as claimed in claim 1, wherein the slow decay phosphor is coated on LEDs in the LED lighting unit.

5. The LED-based lighting module as claimed in claim 1, wherein the slow decay phosphor is comprised in an optical element disposed at the light output paths.

6. The LED-based lighting module as claimed in claim 1, wherein the LED lighting unit comprises a switching mode driving circuit.

7. The LED-based lighting module as claimed in claim 1, wherein the LED lighting unit comprises a linear driving circuit.

8. The LED-based lighting module as claimed in claim 1, wherein the slow decay phosphor is comprised in a cover covering all the light output paths of the LED lighting unit.

9. The LED-based lighting module as claimed in claim 1, wherein the slow decay phosphor is comprised in a plate disposed in front of the LED lighting unit.
